(19) United States
(12) Patent Application Publication
(10) Pub. No.: US 2005/0173364 A1
(43) Pub. Date: Aug. 11, 2005

(54) Method for operating a container crane

(75) Inventors: Heiko Spohler, Hude (DE); Sven Lussen, Stuhr-Neukrug (DE); Uwe Meyer, Elsdorf (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/043,022

(22) Filed: Jan. 25, 2005

Related U.S. Application Data
(63) Continuation of application No. PCT/DE03/02449, filed on Jul. 21, 2003.

(30) Foreign Application Priority Data
Jul. 25, 2002 (DE) 102 33 872.8

(51) Int. Cl. B66C 1/00

(52) U.S. Cl. 212/270; 212/286

(57) ABSTRACT

In a method for operating a container crane of a type having a movable trolley with a height-adjustable container spreader for loading containers to or unloading containers from a transport vehicle, in particular a ship obstacle data or target positions, or both, are acquired before or during loading of the containers on the transport vehicle. The trolley is moved at least in semi-automatic operation either with a received container or without a received container relative to the transport vehicle and positioned relative to a position selected on the transport vehicle in response the acquired data.

### CROSS-REFERENCES TO RELATED APPLICATIONS

This application is a continuation of prior filed copending PCT International application no. PCT/DE2003/002449, filed Jul. 21, 2003, which designated the United States and on which priority is claimed under 35 U.S.C. §120 and which claims the priority of German Patent Application, Serial No. 102 33 872.8, filed Jul. 25, 2002, pursuant to 35 U.S.C. 119(a)-(d).

### BACKGROUND OF THE INVENTION

The present invention relates to a method for operating a container crane for loading containers onto or unloading containers from a transport vehicle, in particular a ship. The present invention also relates to a container crane to carry out the method of the invention, and more particularly to a container crane of a type having a movable trolley with a height-adjustable container spreader from which the containers are suspended.

Nothing in the following discussion of the state of the art is to be construed as an admission of prior art.

A container crane can be used to rapidly load containers onto and unload containers from a transport vehicle, such as a ship, by gripping the containers with container spreaders that are suspended by suitable hoisting cables from a trolley that is movable along a transverse beam. With conventional container cranes, the crane operator sits in an operator cab located on the trolley, i.e., the crane operator moves with trolley and hence also with the container spreader and the container. The operator has to take care that the empty container spreader or a suspended container does not collide with an obstacle on the ship or on the crane. This requires a high level of attention and care when operating the controller that controls the trolley moving gear and the spreader lifting gear.

It would therefore be desirable and advantageous to provide an improved method to obviate prior art shortcomings and to prevent collisions between the spreader and a suspended container, on one hand, and obstacles on the ship, loaded containers, and the like, on the other hand.

### SUMMARY OF THE INVENTION

According to one aspect of the present invention, a method for operating a container crane adapted to load containers onto or unload containers from a transport vehicle, in particular a ship, wherein the crane includes a movable trolley with a height-adjustable container spreader, includes the steps of acquiring before or during loading of the containers obstacle data or target positions, or both, on the transport vehicle, and moving at least in semi-automatic operation the trolley either with a received container or without a received container relative to the transport vehicle and positioning the trolley relative to a position selected on the transport vehicle in response to the acquired data.

The method of the invention proposes, on one hand, to operate the trolley at least semi-automatically by considering data and/or information relating to control of the trolley moving gear and lifting gear and indicating the height of obstacles or target positions on the transport vehicle. In other words, the transport operation, either with or without a container, is controlled semi-automatically by taking into account existing height data of obstacles, such as containers already located on the transport vehicle, or detailed height information of target positions to be accessed, where a container is to be set down or picked up. These data depend on the travel path or the loading position, thereby enabling an accurate correlation of the respective height position with the trolley moving gear. This advantageously provides the crane operator with obstacle data and target data management functionality as a basis for controlling the transport operation, thereby relieving him from duties that could adversely affect the safety of the operation. To the extent that corresponding obstacle data and target position data are available, the moving gear and the lifting gear are controlled so that the spreader or the container suspended therefrom are moved, on one hand, securely across known obstacles and, the other hand, are safely positioned relative to the target position, where the container is to be picked up or set down, without causing collisions.

Advantageously, the data representing obstacles, also referred to as obstacle data, are acquired in form of a height profile along a path of the spreader and displayed on a display. Stated differently, the obstacle data are acquired along the travel path of the spreader by recording the path-dependent height position of the spreader during the travel of the trolley from or to a selected position on the transport vehicle. The obstacle data can be recorded, for example, by performing an empty run, i.e., a run without a container, before the actual loading operation. If a loaded ship is to be unloaded, then the crane operator can record obstacle data by first making an empty run across the entire width of the ship, for example, by moving the spreader across the containers stacked on the ship and following the height profile of the stacked containers perpendicular to the longitudinal direction of the ship, i.e., in the travel direction of the trolley. In other words, obstacle data that form the basis for subsequent semi-automatic control are initially recorded manually. Alternatively, the obstacle data can also be acquired during the loading operation by recording the respective spreader height and path coordinates. With this process, travel is first manually controlled to a selected position on the transport vehicle by recording the obstacle data during the travel to the selected position, whereafter travel can be automatically controlled over the recorded path segment. Travel to a position outside the recorded path segment is controlled manually, because a semi-automatic operation can only be performed within the known path segment. However, a semi-automatic operation may generally not be allowed under these circumstances. The obstacle data for positions that have not yet been accessed are set to a maximum value, wherein the maximum value is overwritten when an actual data point of an obstacle is measured. For example, at the beginning of a loading operation, the obstacle data can generally be set to a maximum value, where the spreader is moved at its greatest height. After the spreader is lowered to access a particular target position, the corresponding path-related or position-related maximum value can be overwritten accordingly.

Advantageously, obstacle data are acquired with a predefined position grid having a grid spacing of, for example, from 0.01 m to 0.99 m, in particular 0.5 m.

While the obstacle data are primarily intended for controlling the horizontal travel and height of the spreader, the target position data are primarily intended for precise semi-automatic positioning of the spreader relative to the selected target position. In addition, the obstacle data can be updated based on the target position data that can be determined based on the height of the spreader when the container is gripped and/or set down, because the height of an empty spreader follows the height of the spreader gripping a container. The target position data and hence also the container data advantageously describe a height of a container or a container stack as a function of a loading position, whereby the target position data are associated with the target positions by taking into account a width of a container. The target position data together with the container width can be displayed on a display as a function of the loading position. The data are displayed and acquired according to the rows of the load bay. Several load rows, where containers are or can be stacked, are defined transversely to the lengthwise direction of the ship. The rows themselves are defined when a container is first accessed or when a container is first set down, because the width of a container is known, and the subsequent row positions can be computed based on the spacing between containers. The row coordinates are advantageously defined as the midpoint of the spreader. For safety reasons, the target position data of target positions that have not yet been accessed, in particular at the beginning at the semi-automatic loading operation, can be determined based existing obstacle data for this target position, e.g., after one row has already been traversed once by the spreader. Otherwise, the rows are advantageously set to a maximum value which is overwritten when an actual target position is acquired. The maximum value can be set, for example, to a corresponding maximum value of the curve representing the obstacle data.

Due to the separation between two container rows in the load bay, target position data may not exist for an intermediate position, so that a maximum value for this position may have to be derived from the obstacle data, which can cause a peak in the target position data curve. To disregard such peaks during a subsequent semi-automatic travel and to prevent the spreader from being raised over an obstacle that does not actually exists, the target position data can be intermittently smoothed. For example, it can be checked if a narrow peak is likely to be an obstacle based on the existing obstacle data, i.e., on the obstacle curve. If the peak is an actual obstacle, then the actual obstacle data curve at that point should be located above the peak. Also feasible would be a plausibility check with respect to adjacent target position data.

Advantageously, the obstacle and target position data can be acquired relative to the defined positions of the container crane along a longitudinal direction of the transport vehicle. The containers are or can be loaded into load bays defined on the ship. The container crane must be precisely positioned relative to the load bays which form the reference for the corresponding acquired data. A particular load bay can be associated with each crane position, with the width of the load bay determined by the maximum length of a container to be loaded. For example, if long containers with a maximum length of 45 foot are to be loaded, then the width of the corresponding load bay is slightly greater than 45 foot, with the crane being positioned in the center. Because two narrow containers can also be placed sequentially in a wide load bay, which maximally have half the dimension of the containers that determine the width of the bay, such containers can advantageously be loaded if obstacle data are acquired in that load bay for each resulting narrower load bay as well as for the original load bay itself. Stated differently, so-called “sub-bays” with known obstacle data profiles and target position data profiles are formed, because the spreader has to be able to access defined positions within these “sub-bays” with a potentially different obstacle profile, while preventing collisions. For example, a 45 foot long container must not be placed at a target position that already holds a 20 foot long container, because the 45 foot long container may tip.

Advantageously, the obstacle data and/or the target position data can be continuously acquired and updated during the loading operation. For example, the obstacle curve can be updated depending on the trolley travel and/or the spreader movement, whereas the target position data and/or the container data can be updated depending on the actual loading or access operation. For example, if the spreader places a container on top of another container and therefore has to be raised to a position or stop at a position higher than a previously measured position before setting the container down, then the travel path is automatically updated, because height of the container to be set down is known and a subsequent container suspended from the spreader must move across the container having the known height. In other words, the obstacle data are updated indirectly by way of the target position data and container height data. During loading, the target position data are defined and updated based on the respective spreader position, whereas during unloading, the target position data are updated based on the difference of the spreader position, when the container to be unloaded is gripped, and the known container height of the gripped container. This difference indicates the height of the upper surface of the container located below.

When loading or unloading a ship, tidal changes may cause the ship's position to rise or fall, thereby changing the actual target position data. This can be compensated by correcting all stored target position data of the actual load bay each time a difference is detected between a known target position data point and an actual measured target position data point having a height greater than the known target position data point. Stated differently, if a known target position data point defines a particular height z based on an earlier access to the same container row, and if a later access to the same container row detects that the spreader already grips the desired container at a height z+Δz, then it can be inferred that the ship has been lifted by the tide. All stored target position data for that bay are then advantageously corrected by the measured Δz to prevent the lowered spreader from colliding with the container that actually has at a greater height. A correction is not required when the ship's position falls at low tide, because this does not cause a problem.

If containers are loaded into the interior cargo hold of a ship and a difference is detected between a known or actually acquired target position data point, regardless of the direction, then the target position data stored for the actual load bay in the interior cargo hold of the ship are corrected for each of the two measured directions. Because for safety reasons containers loaded into an interior cargo hold must be lowered manually from the height of the deck or be raised to the height of the deck during unloading, the data can be corrected for both directions.

According to the invention, the vertical movement of the loaded or empty spreader is controlled semi-automatically during the trolley travel depending on the obstacle and/or target position data. The spreader is therefore raised or lowered during the travel to the target position as permitted by the existing data. Advantageously, the spreader is semi-automatically positioned at a defined distance above the actual the target position that depends on the load of the spreader, whereafter the spreader must be controlled manually for gripping or setting down the container. The spreader is therefore automatically positioned above the height of the target position at a specified safety distance, whereby this distance can be parameterized. A value of 0.5 m can be preset, and this value can be increased or decreased as necessary. The safety distance is defined relative to the underside of the spreader for an empty spreader and relative to the underside of the suspended container for a loaded spreader. The crane operator must always use manual control for gripping or setting down the container.

To maintain a safety distance when positioning the spreader relative to existing containers, the trolley and the spreader can be positioned during travel at a predefined distance before or after the target position, or directly above the target position, depending on the path-dependent obstacle or target position data. The final position depends in the container profile. If two container stacks with different height of placed next each other and, for example, the lower container stack is to be accessed, then the spreader is positioned at a defined safety distance from the actual target position directly above the lower container stack, because otherwise a collision could occur with the higher container stack. No safety offset is necessary when the container stacks have the same height. A lateral offset must be corrected by relying on data from the previous manual loading operation. The lateral separation can be parameterized like the height separation and can be, for example, 0.5 m.

According to another embodiment of the invention, the containers can be loaded into an interior cargo hold of a ship by moving the spreader semi-automatically to or from a defined height position outside the cargo space located below deck, and can be controlled manually from or to that defined height position. An automatic operation in the actual cargo space below deck is not permitted. The height position to or from which an automatic operation is permitted, is advantageously defined relative to the position of a cargo hatch, which can be measured, for example, by gripping the cover with the spreader for opening the cargo hatch. Alternatively, the height of the cargo hatch can be determined based on the known height of a container and the spreader position when the container is set down directly on the deck.

Several sets of obstacle data and/or target position data relating to the load bays can be simultaneously stored in a controller of the crane. This is particularly advantageous when forming “sub-bays” because data for both the double-wide bay itself and for the two “sub-bays” have to be available for a safe operation.

According to an advantageous feature of the invention, when the crane operator accesses a load bay, the controller checks for existing obstacle data or target position data before containers are loaded into that load bay. This could be the case if the crane has already operated in this load bay a short time ago, because data for that bay are only temporarily stored in the controller, for example, for 30 minutes, as a rising tide may change the data. Any missing obstacle or position data can be loaded into the controller form a crane-external mainframe computer, which can also provide movement instructions for the loading or unloading operation.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a container crane according to the invention;

FIG. 2 shows a schematic diagram in cross-sectional view through a loaded ship and movement of the spreader;

FIG. 3 shows schematically an obstacle data curve;

FIG. 4 shows a schematic diagram of target position data for container stacks;

FIG. 5 shows an obstacle data curve as a function of target position data, derived by combining FIGS. 3 and 4;

FIG. 6 shows the diagram of FIG. 5 after smoothing; and

FIGS. 7a to 8b are diagrams of the target position and the actual positioning of the spreader for different container arrangements.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

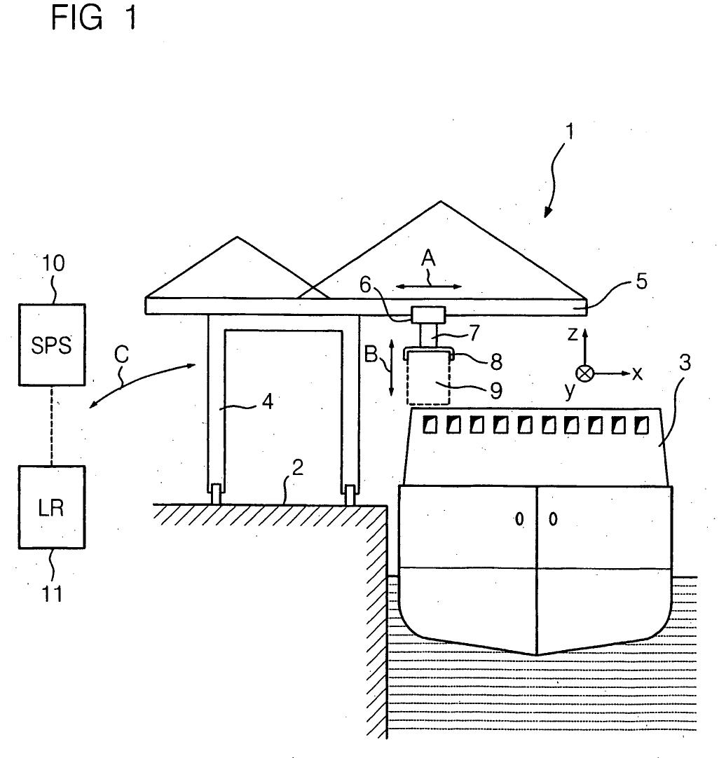

Turning now to the drawing, and in particular to FIG. 1, there is shown a schematic diagram a container crane 1 according to the invention, which can be moved by a motor-driven traveling gear parallel to a quay wall 2 along a ship 3. The crane frame 4 has a transverse beam 5 that completely extends over the width of the ship 3. A trolley 6 (double arrow A) can move on the transverse beam 5, with a container spreader 8 suspended from the trolley 6 by hoisting cables 7. The spreader 8,which in the illustrated example grips a container 9 indicated by dotted lines, can be moved in the vertical direction by the hoisting cables 7 and a hoisting gear disposed on the trolley 6, as indicated by the double arrow B. The entire operation of the crane is controlled by a stored-program controller (SPS) 10 internal to the crane, as indicated by the double arrow C. The controller 10 acquires relevant data from the operating elements of the crane, controls the operating elements, and displays the data. The illustrated exemplary controller 10 is connected with an external mainframe computer (LR) 11 which stores the movement or travel instructions, the information of the load bay to be accessed (i.e., the position of the crane relative to the side of the ship) as well as the row position, where a container is gripped and set down, etc. The controller 10 is configured to automatically move the trolley 6 as well as the spreader hoisting gear under semi-automatic control. Automatic travel is enabled when the targets and the obstacles on board of the ship have been identified.

The target position data and obstacle data for targets and obstacles onboard the ship 3, respectively, are always determined relative to a load bay. The entire cargo space of the ship is subdivided into several load bays, whereby the container crane 1 moves along the quay to a position relative to a specific bay, where the containers are to be loaded and/or unloaded. A load bay can consist of a 20 foot container, a 44 foot container, a 45 foot container, or to two 24 foot containers placed side-by-side. A load bay includes both of the section above deck as well as the section located below of the height of the cargo hatches. A loading position is considered as being associated with a load bay, if its y-coordinate, which in the coordinate system depicted in FIG. 1 is in the drawing plane, is located within the valid range of a respective load bay. Only one common y-coordinate is stored for all loading or target positions within a particular bay, and this common coordinate is considered to represent the y-coordinate of the entire load bay, thus unambiguously identifying the load bay in the entire system. The valid range of a load bay is, for example, approximately ±50 cm, referenced to the measured crane position, and can be measured by suitable sensors, for example by transponders, etc., located on the ground. If the crane is located relative to the bay inside the valid range, then the crane is properly positioned, i.e. the crane is associated with that bay. Otherwise, the crane has to be repositioned.

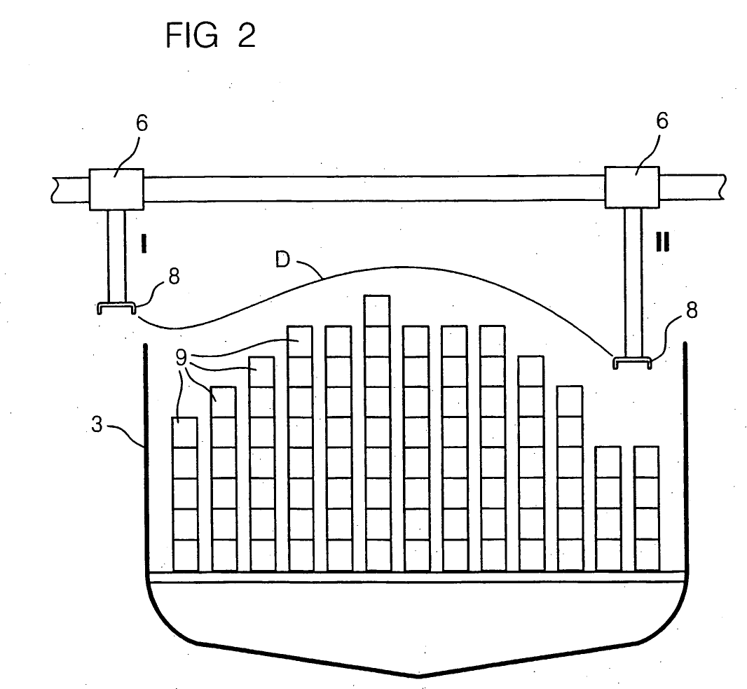

FIG. 2 shows a typical cargo arrangement in a load bay, whereby several bays are arranged sequentially in the drawing plane, i.e., along the y-coordinate, as described above. The containers 9 are placed on top of each other to form container stacks of different height, thus forming a hillock-shaped height profile.

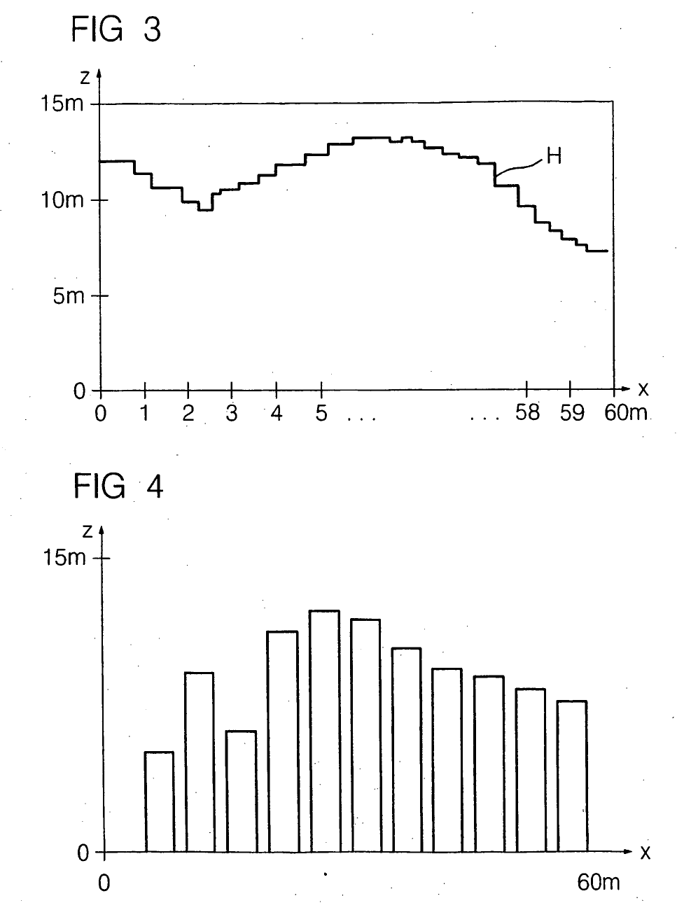

Obstacle data and target data must be acquired for semi-automatic operation. If the ship depicted in FIG. 2 is to be unloaded, then the crane operator positions the crane in front of the desired load bay and first scans the height profile of the container rows in the load bay. The crane operator moves the empty trolley initially from the position I to the position II, while guiding the spreader 8 across the containers with a close vertical spacing above the container stacks, and indicated by the travel curve D. The position of the container during this movement is acquired continuously in a grid with a predetermined grid spacing, e.g., every 0.5 m, resulting in the curve with height position data depicted in FIG. 3, which shows the obstacle data in form of an obstacle curve H. The distance x of the spreader transverse to the ship 3 is recorded along the abscissa (x-coordinate), whereas the measured height position of the spreader at a corresponding x-coordinate is recorded on the ordinate (z-coordinate). In the depicted embodiment, the transverse beam has a length of 60 m, and the maximum height of the spreader during travel with reference to the plane of the quay wall is 15 m. The recorded obstacle data, depicted in the form of the obstacle curve H, represent the height of obstacles, i.e., container stacks, on the ship 3 that have to be taken into consideration during automatic movements. The trolley moving gear as well as the lifting gear and hence also the movement of the trolley and the spreader across the container stack are controlled semi-automatically based on the scanned obstacle curve H.

The actual spreader height is recorded as z-coordinate for each access to a container of one of the container rows, i.e., for a corresponding x-coordinate. If the spreader is empty, the z-coordinate representing the target position in the hoisting direction is indicated for the underside of the empty spreader, whereas the z-coordinate is referenced to the underside of a container when the spreader holds a container. If the container height is not known, then a container height of, for example, 3 m, can be defined via an adjustable parameter. The target position in the travel direction of the trolley or the crane, i.e., the x-coordinate, is referenced to the center of the spreader.

FIG. 4 shows a typical target position data profile for individual container stacks, whereby the upper ends of the column-shaped stacks indicate the respective z-coordinate which correspond to the actual height of the target position. The target position data of a container stacks are updated with each access to that container stack, either for gripping or for unloading a container or for setting down a loaded container, by acquiring and storing in the controller either the new, smaller z-coordinate (during unloading) or the new greater z-coordinate (during loading). At the same time, the obstacle data are updated (locally increased or decreased), because the z-coordinate of the actual obstacle and/or of the target position may have changed at the corresponding x-position, which has to be taken into account during automatic operation. This diagram can also be referred to as “C-curve” because of its curved profile.

If it is determined during a movement to a known target position, i.e., to a container stack with a known height, that the tide has lifted the ship 3, the data can still be corrected automatically. In this case, the spacing between the obstacle curve H which essentially represents the travel curve, and thus the distance between the obstacle data along the path and the actual obstacle, i.e., the container stack, is smaller then has been previously measured. All obstacle data and target position data relating to this bay are then corrected by the determined Δz, as determined by comparing the stored target position data point with the actually measured target position data point.

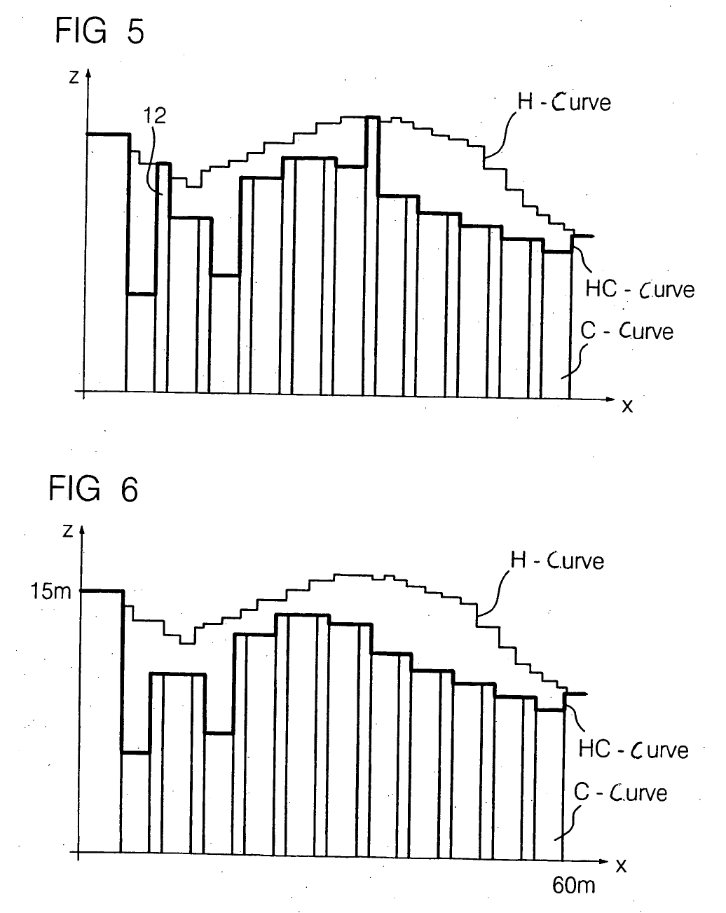

FIG. 5 shows the resulting obstacle-target position data curve (HC-curve) derived by combining the curves shown in FIGS. 3 and 4. As also indicated, peaks 12 can show up in the data curve as a result of the grid. The resulting curve is therefore smoothed, after the entire curve depicted in FIG. 5 has been computed, by giving the peaks the maximum z-value of the obstacle curve, since otherwise such peaks would indicate an obstacle to be considered during the next path.

FIG. 6 shows a computed inclusive curve or illustration of the obstacle and target position data relevant for controlling the travel and hoist controller. In semi-automatic operation, the empty or loaded spreader 8 is positioned with a predetermined offset from the actual target position, vertically or optionally also laterally. From there on, the spreader can only be moved by manual control.

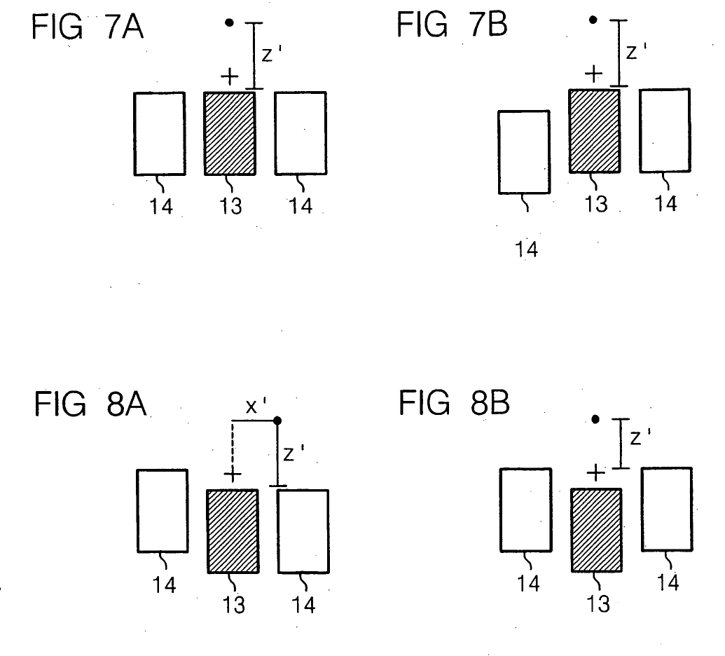

FIGS. 7a-8b show different loading situations that lead to different positions of the spreader. In the examples illustrated in FIGS. 7a-8b, the container indicated by hatching is assumed to be gripped with the spreader. The “+”-sign indicate the respective target position that is always located above the container to be gripped, whereas the “•”-symbol indicates the respective end position of the spreader at the end of the automatic travel.

FIG. 7a depicts a situation where the center container 13 is to be gripped and the two containers 14 on either side of container 13 are at the same height as container 13. The container height, i.e., the target position data for the top side of the containers, is known for all containers. The spreader is positioned directly above the container 13 to be gripped with a safety distance z′.

FIG. 7b shows a similar situation, whereby the bottom of the left container 14 is below that of the other two containers 13 and 14. Here, too, the spreader is positioned with the safety distance z′ directly above the container 13 to be gripped.

FIG. 8a shows the opposite situation of FIG. 7b, i.e., the left container 14 is higher than the adjacent containers 13, 14. In automatic operation, the spreader is then positioned not only by the safety distance z′ in the vertical direction (height), but also by a lateral safety distance x′ relative to the actual target position, which is based on the minimum distance between the two containers. In the example depicted in FIG. 8a, the spreader is positioned slightly to the right by a distance x′ and must be manually controlled from this position on.

FIG. 8b shows a situation where the two containers 14 are higher than the container 13 to be gripped. The spreader is then positioned directly above the container 13, however with a distance z″ from the container 13 which is greater than the previously used safety distance z′, because the safety distance z′ must be added to the height, i.e., the z-coordinate, of one of the containers 14.

The controller 10 computes the actual end position in automatic operation based on the known obstacle data and target position data depending on the desired travel instructions provided to controller 10 by a mainframe computer 11. The semi-automatically controlled travel always concludes with a safety distance from the target position, whereafter the crane operator must move to the end position manually.

In addition, an oscillation control system can use the obstacle data and/or target position data for controlling pendulum oscillations of the spreader.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for operating a container crane constructed to load the container to or from a transport vehicle, in particular a ship, comprising the steps of:
acquiring before or during loading of a container obstacle data or target positions, or both, on a transport vehicle, and
moving at least in semi-automatic operation a trolley of the container crane either with a received container or without a received container relative to the transport vehicle and positioning the trolley relative to a position selected on the transport vehicle in response to the acquired data.

2. The method of claim 1, wherein the obstacle data are acquired in form of a height profile along a path of a height-adjustable spreader of the container crane and displayed on a display.

3. The method of claim 1, wherein the obstacle data describe a height of a height-adjustable spreader of the container crane as a function of a traveled distance of the trolley from or to the selected position on the transport vehicle.

4. The method of claim 3, wherein the obstacle data are acquired in the context of an empty run before or during the actual loading operation.

5. The method of claim 3, wherein the obstacle data for positions that have not yet been accessed are set to a maximum value, wherein the maximum value is overwritten when an actual data point of an obstacle is measured.

6. The method of claim 3, wherein the obstacle data are acquired with a predefined position grid.

7. The method of claim 6, wherein the obstacle data are acquired with a grid having a grid spacing between 0.01 m to 0.99 m.

8. The method of claim 6, wherein the obstacle data are acquired every 0.5 m with a grid having a grid spacing.

9. The method of claim 1, wherein the target position data describe a height of a container or a container stack as a function of a loading position.

10. The method of claim 9, wherein the target position data are associated with the target positions by taking into account a width of a container, and wherein the target position data together with the container width are displayed on a display as a function of the loading position.

11. The method of claim 9, wherein the target position data are determined when the container is gripped or set down based on a hoisting height of a height-adjustable spreader of the container crane.

12. The method of claim 9, wherein the target position data for target positions that have not yet been accessed are either determined based on already existing obstacle data for the particular target position, or are set to a maximum value, wherein the maximum value is overwritten when actual target position data are measured.

13. The method of claim 9, wherein the target position data for target positions that have not yet been accessed at the beginning of the semi-automatic loading operation, are either determined based on already existing obstacle data for the particular target position, or are set to a maximum value, wherein the maximum value is overwritten when actual target position data are measured.

14. The method of claim 9, wherein the target position data are intermittently smoothed.

15. The method of claim 1, wherein the obstacle data and target position data are acquired relative to a defined position of the container crane along a longitudinal direction of the transport vehicle.

16. The method of claim 15, wherein a load bay is associated with each position of the container crane, with a width of the load bay depending on the maximum length of the loaded container.

17. The method of claim 16, wherein during loading of a smaller container having a length that is half the maximum length of a container, obstacle data are acquired for each resulting narrower load bay, as well as separate obstacle data for the load bay.

18. The method of claim 1, wherein the obstacle data or the target position data, or both, are acquired and updated continuously during the loading operation.

19. The method of claim 18, wherein each time a difference is detected between a known target position data point and an actual measured target position data point with a height greater than the known target position data point, all stored target position data of the actual load bay are corrected.

20. The method of claim 19, wherein if a container is loaded into an interior cargo space of a ship and a difference is detected between the known target position data point and the actual measured target position data point, then the target position data stored for the interior cargo space of the ship and related to the current load bay are corrected both for a rise and a drop in the ship's position.

21. The method of claim 1, wherein in semi-automatic operation, the vertical movement of a loaded or empty spreader of the container crane during travel of the trolley is controlled depending on the obstacle data or target position data, or both.

22. The method of claim 21, wherein in semi-automatic operation the spreader is positioned at a defined distance above the actual height of the target position that depends on the load of the spreader, whereafter the spreader is controlled manually for gripping or setting down the container.

23. The method of claim 20, wherein the defined distance is parameterized.

24. The method of claim 22, wherein the defined distance is between 0.3 m and 1 m for an empty spreader, as measured from the spreader, and 0.3 m and 1 m for a loaded spreader as measured from an underside of a gripped container.

25. The method of claim 22, wherein the defined distance is 0.5 m for an empty spreader, as measured from the spreader, and 0.5 m for a loaded spreader as measured from an underside of a gripped container.

26. The method of claim 1, wherein in semi-automatic operation, the trolley and a height-adjustable spreader of the container crane are positioned during travel a predefined distance before or after the target position, or directly above the target position, depending on the path-dependent obstacle or target position data.

27. The method of claim 26, wherein the distance can be parameterized.

28. The method of claim 1, wherein if the containers are loaded into an interior cargo space of a ship, then a height-adjustable spreader of the container crane is moved semi-automatically to or from a defined height position outside the cargo space located below deck, and is controlled manually from or to the defined height position.

29. The method of claim 28, wherein the height position is defined relative to a position of a cargo hatch.

30. The method of claim 1, wherein the container crane includes a controller storing several sets of loading-bay-related obstacle data or target position data, or both.

31. The method of claim 30, wherein a check for existing obstacle or target position data is performed in the controller before containers are loaded in a load bay, and wherein missing obstacle or position data are loaded into the controller form a crane-external mainframe computer.

32. A container crane for load containers to or from a transport vehicle, comprising:
a moving gear adapted to move the crane along a quay wall;
a frame mounted on the moving gear and supporting a transverse beam;
a trolley movable on the transverse beam;
a height-adjustable container spreader suspended from the transverse beam; and
a controller for controlling operation of the crane by acquiring before or during loading of the containers obstacle data or target positions, or both, on the transport vehicle, and moving at least in semi-automatic operation the trolley either with a received container or without a received container relative to the transport vehicle and positioning the trolley relative to a position selected on the transport vehicle in response to the acquired data.
